(19) United States
(12) Patent Application Publication
(10) Pub. No.: US 2012/0242063 A1
(43) Pub. Date: Sep. 27, 2012

(54) Device and System for Transporting and Dispensing Cables and Wires

(76) Inventor: Carl Bruckner, Washington, PA (US)

(21) Appl. No.: 13/053,486

(22) Filed: Mar. 22, 2011

(51) Int. Cl. B62B 3/04; B62B 1/12; B62B 3/02; B62B 1/14

(52) U.S. Cl. 280/651

(57) ABSTRACT

A device and system for transporting and dispensing cable and wire in which the device includes a system to secure cable boxes on the cart and locking casters to stabilize the device.

### BACKGROUND

1. Field of the Invention

This disclosure relates to the field of hand delivery devices. In particular, to the field of hand dollys and carts for transporting and dispensing cables and wires and systems for conducting the same.

2. Description of the Related Art

Electronic devices, and computers in particular, have become ever more connected. Today, people from around the world are connected to computer networks which are both local and worldwide in scope. Cables and wires have provided the necessary means to connect and transmit across these networks and the use spreads across all markets, including entertainment and broadcast, industrial, sound and security, data networking, residential and government.

All these markets require significant installation efforts, whether it be in new construction or an existing building. Also, the customer oftentimes requires an abundance of cables and/or wires of differing varieties, including multi-conductor, paired, coaxial, flat and optical fiber cables, portable cordage, molded cable assemblies, hook-up and lead wire. In a standard wire installation scenario, the cable and wire are wound around reels and stored in boxes. Examples of such storage systems are disclosed in U.S. Pat. Nos. 6,991,197 and 5,897,075, the entire disclosures of which are herein incorporated by reference. Such reels are used both to store and facilitate the dispensing of the cable and wire. Other times, though, the cable may only be coiled inside the box, without the use of a reel. However, in either case, the friction and resistance of the cable inside the box (with or without the reel) often makes the removal of the cable and wire a difficult task and past practices have demonstrated a lack of a secured method and device for restraining the boxes of cable. As a result, the installation results in either the box flailing across the floor, causing damage and injury, or the use of two workers—one to secure the box and one to remove the cable—increasing labor costs.

Furthermore, the location of cable and wire installation and use is geographically separated from the jobsite delivery of the boxes of reels. In the past, the installers would use a standard two-wheeled dolly to deliver the cable boxes to the installation and usage area. Such a device and method, however, has significant problems in that its use often requires bad posture by the user, making it ergonomically unacceptable and leading to accidents, injuries, and damage and loss of the products.

There have been attempts to correct the above described problems, for example as in U.S. Patent Application Pub. No. US 2009/0191436 A1 to Galgano, et al. These devices and systems, however, have problems of there own. For example, these are specially designed devices which can only transport cable boxes of the same size and require that the cable be stored, transported, and dispensed from a specialized box (including a reel) designed to interface with the specially designed transport device. Furthermore, these previous designs were generally unable to convert among various positions, and particularly were unable to convert among the various positions while the cargo was secured thereon.

Accordingly, there is a need for a safer and more efficient system of transporting and dispensing cables and wires in boxes of all shapes, sizes, and types, and without the need for a specially designed device which interfaces with the specific boxes.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is, among other things, a hand delivery device for transporting and dispensing cable and wire, the device comprising: a handle assembly having a top end and a bottom end; a caster connected to the bottom end of the handle assembly; a movable loading base having a proximal end and a distal end, wherein the proximal end of the movable loading base is hingedly connected to the bottom end of the handle assembly; a wheel connected to the distal end of the movable loading base; a guide rail hingedly connected to the movable loading base; and a retractable ratchet tie-down having a strap, wherein the retractable ratchet tie-down is connected to the device at the proximal end of the movable loading base and wherein the strap adjustably and removably attaches to the distal end of the movable loading base.

In certain embodiments, the caster further comprises a plurality of swivel casters including at least one foot-activated locking lever. In one embodiment, the wheel further comprises a plurality of tires. In another embodiment, the plurality of tires are pneumatic tires.

The device may also include a handle connected to the top end of the handle assembly. In one embodiment, the handle further comprises an elastomer grip.

Also disclosed herein is a system for transporting and dispensing cable and wire comprising: a plurality of cable wire boxes; and a hand delivery device comprising: a handle assembly having a top end and a bottom end; a caster connected to the bottom end of the handle assembly; a movable loading base having a proximal end and a distal end, wherein the proximal end of the movable loading base is hingedly connected to the bottom end of the handle assembly; a wheel connected to the distal end of the movable loading base; a guide rail hingedly connected to the movable loading base; and a retractable ratchet tie-down having a strap, wherein the retractable ratchet tie-down is connected to the device at the proximal end of the movable loading base and wherein the strap adjustably and removably attaches to the distal end of the movable loading base.

In certain embodiments, the retractable ratchet tie-down is connected to the bottom end of the handle assembly. In other embodiments, the hand delivery device further comprises a plurality of swivel casters connected to the bottom end of the handle assembly and wherein the swivel casters includes at least one foot-activated locking lever.

In certain embodiments, the wheel of the hand delivery device further comprises a plurality of tires. In one embodiment, the plurality of tires are pneumatic tires.

In another embodiment, the hand delivery device further comprises a handle connected to the top end of the handle assembly. In one embodiment, the handle further comprises an elastomer grip.

In certain embodiments, the plurality of cable wire boxes are different sizes. In yet another embodiment, the plurality of cable wire boxes further comprise at least one cable wire box without a reel.

Also disclosed herein is a system for transporting and dispensing cable and wire comprising: a plurality of cable boxes; a hand delivery device comprising: a handle assembly having a top end and a bottom end; a caster connected to the bottom end of the handle assembly; a movable loading base having a proximal end and a distal end, wherein the proximal end of the movable loading base is hingedly connected to the bottom end of the handle assembly; a wheel connected to the distal end of the movable loading base; and a guide rail hingedly connected to the movable loading base; and a means for securing cable boxes such that the cable boxes are secured thereby to the hand delivery device.

In certain embodiments, the plurality of cable wire boxes are different sizes. In yet other embodiments, the plurality of cable wire boxes further comprise at least one cable wire box without a reel.

### BRIEF DESCRIPTION OF THE DRAWINGS

FIG. 1 shows a perspective view of an embodiment of the hand delivery device configured in the angled cart position.

FIG. 2 shows a perspective, rear view of an embodiment of the hand delivery device configured in the two-wheeled dolly position.

FIG. 3 shows a perspective, front view of an embodiment of the hand delivery device configured in the two-wheeled dolly position.

FIG. 4 shows a perspective view of an embodiment of the hand delivery device configured in the flat cart position.

FIG. 5 shows a perspective view of the casters of an embodiment of the hand delivery device configured in the flat cart position.

FIG. 6. shows a perspective view of the retractable ratchet tie-down of an embodiment of the hand delivery device configured in the two-wheeled dolly position.

FIG. 7 shows a perspective view of an embodiment of the hand delivery device configured in the angled cart position with cable boxes attached and secured by the retractable ratchet tie-down.

FIG. 8 shows a perspective view of an embodiment of the hand delivery device configured in the flat cart position with cable boxes attached and secured by the retractable ratchet tie-down.

FIG. 9 shows a bottom perspective view of the wheels of an embodiment of the hand delivery device configured in the flat cart position.

FIG. 10 shows a perspective view of an embodiment of the hand delivery device configured in the angled cart position with a cable guide.

FIG. 11 shows a perspective view of an another embodiment of the hand delivery device.

FIG. 12 shows a perspective view of the embodiment of FIG. 11 configured in the folded position.

FIG. 13 shows a perspective view of the embodiment of FIG. 11 with cable boxes attached and secured by the retractable ratchet tie-down.

### DETAILED DESCRIPTION OF PREFERRED EMBODIMENTS

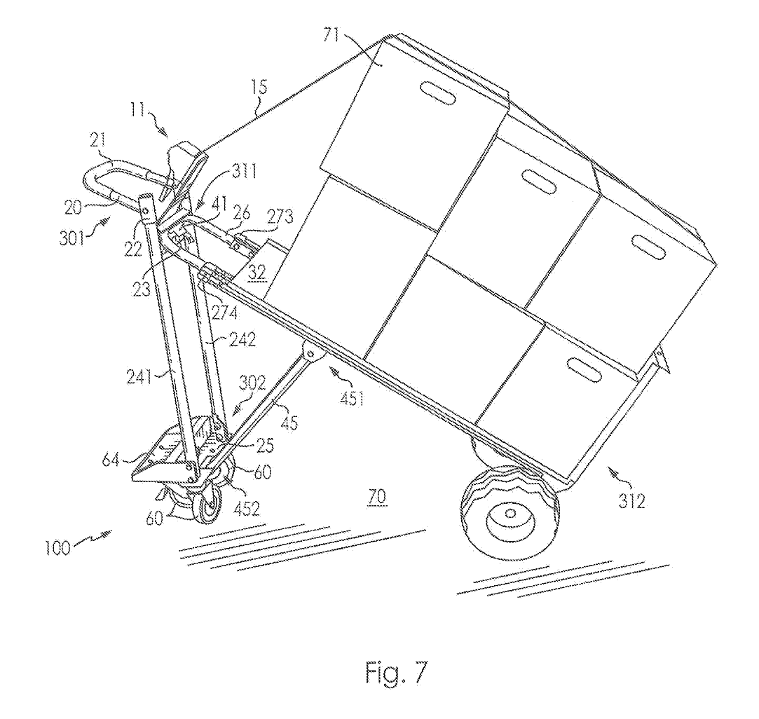

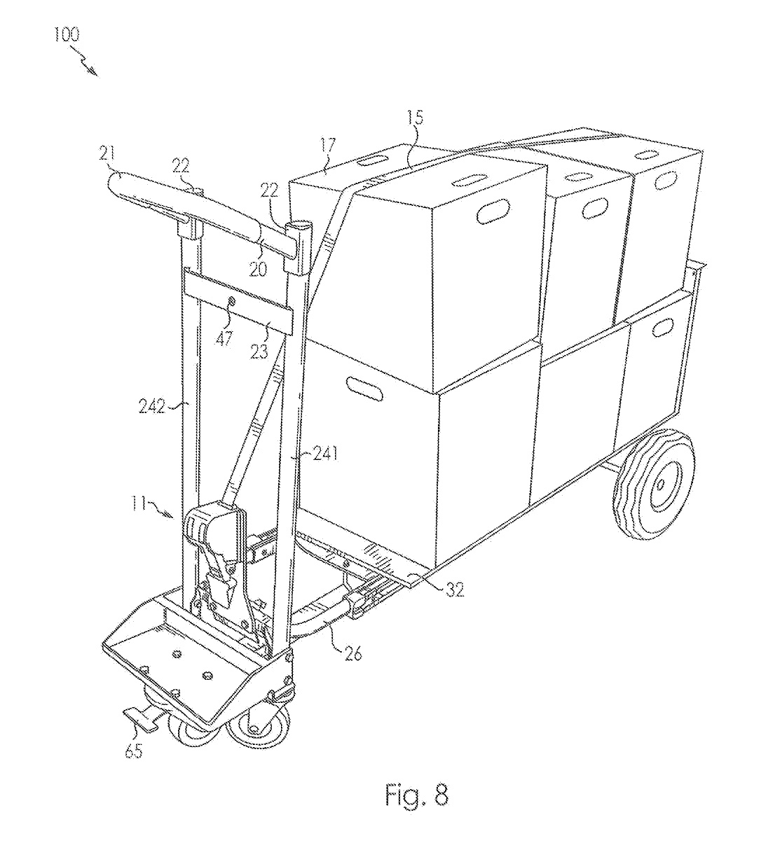

The following detailed description illustrates by way of example and not by way of limitation. Described herein, among other things, is a system for transporting and dispensing cable and wires. In an embodiment, this comprises a hand delivery device (100) with a securing system (19), such as that shown in FIGS. 7-8. The securing system (19) serves both to secure the cargo while transporting to the installation site and for aiding in the cable wire removal. The system will generally be designed to hold cable wire boxes (71), which would generally include cable inside a box either spooled with or without a reel inside the box (71). These boxes (71) are described generally herein when discussing embodiments, and a person of ordinary skill in the art would recognize that the securing means could be used to secure any type of cargo. Furthermore, the cable wire boxes (71) may or may not contain a reel inside the box (71).

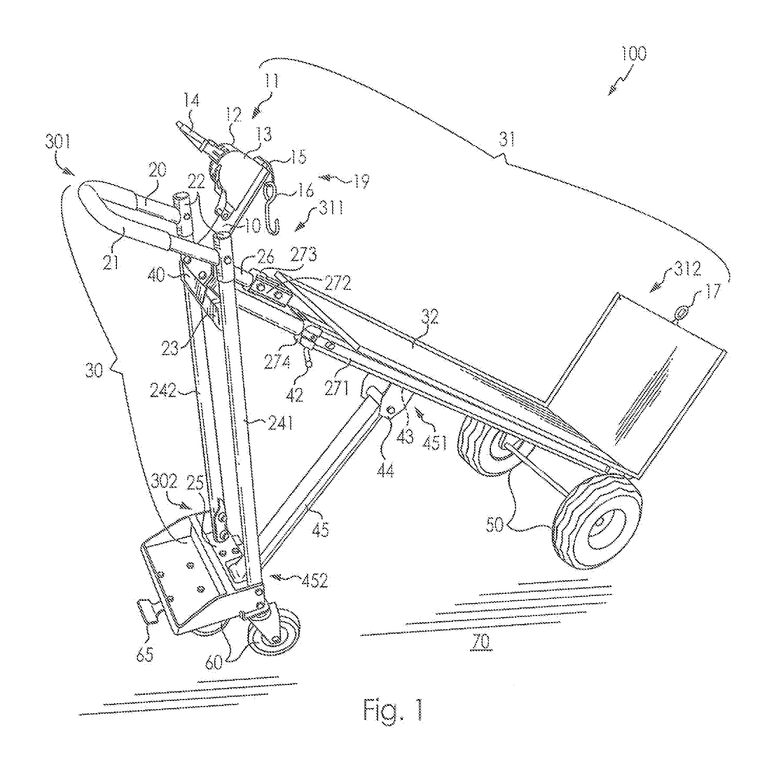

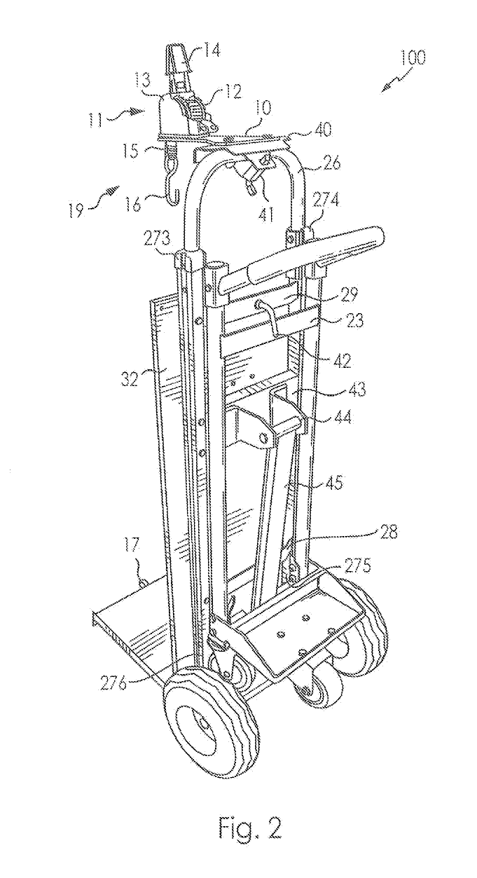

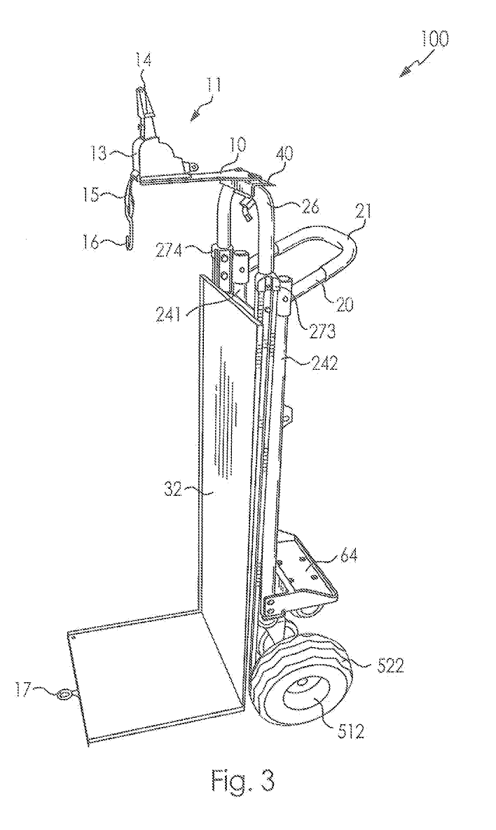

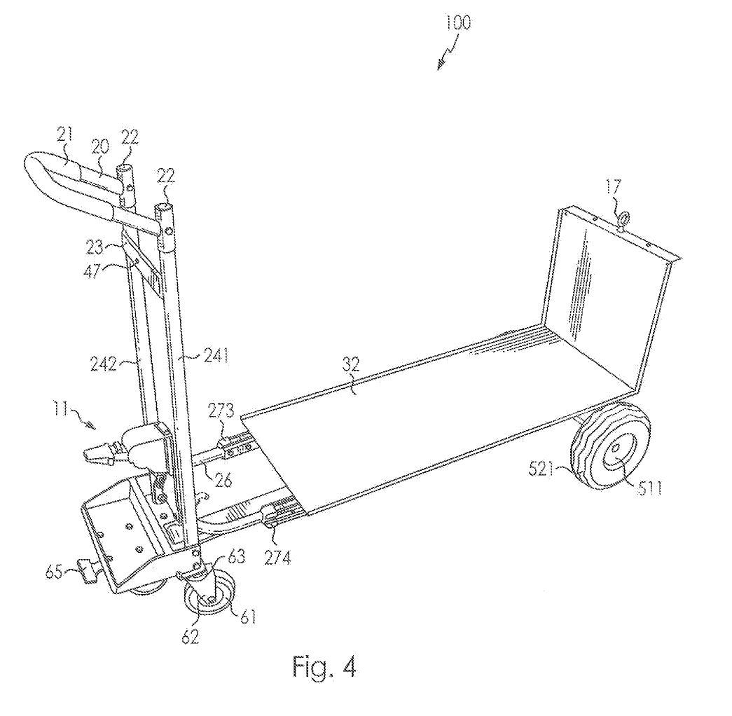

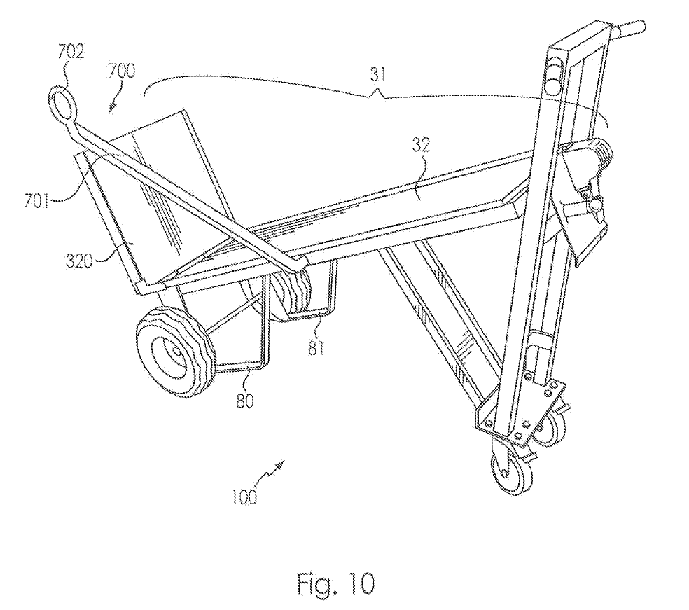

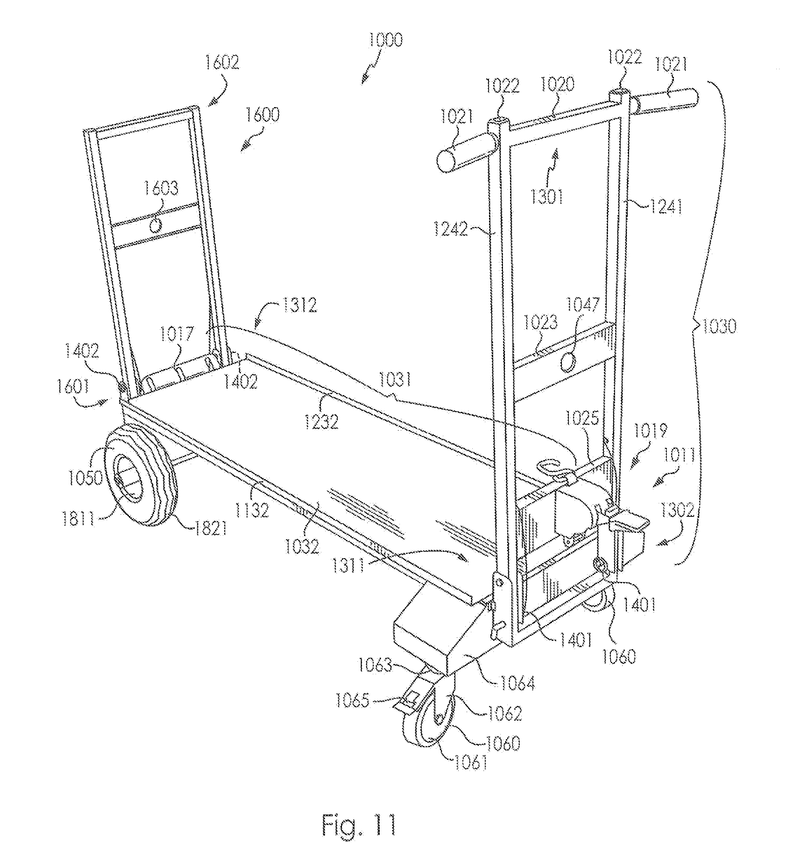

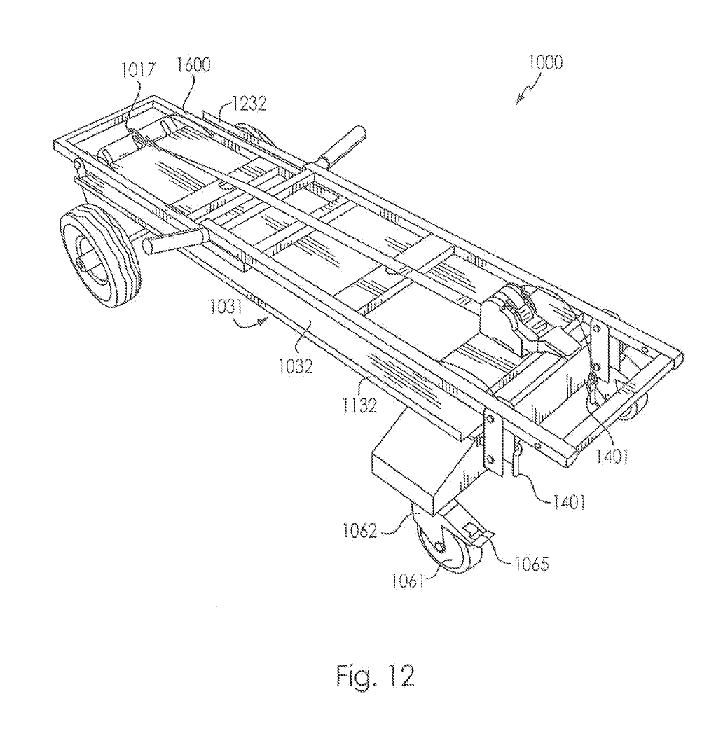

In a first embodiment, the hand delivery device (100) is capable of converting between a flat cart (as shown in FIGS. 4 and 8), an angled cart (as shown in FIGS. 1 and 7), and a two-wheeled dolly (as shown in FIGS. 2 and 3). In an alternative embodiment, the hand delivery cart (1000) may be limited to a flat cart position (as shown in FIGS. 10-11), but that can convert into a storage form (as shown in FIG. 12).

In this embodiment, the hand delivery device (100) includes a securing system (19) and a movable loading base (31) with wheels (50) connected thereto and a handle assembly (30) with casters (60) connected thereto. The movable loading base (31) and the handle assembly (30) generally both hingedly connect to a link (45) at opposite ends thereof, as shown in FIGS. 1 and 7. As defined herein, the link (45) has a proximal end (452) and a distal end (451), with the handle assembly (30) connected to the proximal end (452) and the movable loading base (31) connected to the distal end (451). As suggested by FIGS. 1, 2, and 4, the hand delivery device (100) can be converted from the two-wheeled dolly position (FIG. 2) to the angled cart position (FIG. 1) to the flat cart position (FIG. 4) by adjusting the position of the movable loading base (31) relative to the handle assembly (30).

The movable loading base (31), as defined herein, has a proximal end (311) and a distal end (312), is load bearing, as shown in FIG. 7-8, and includes two loading support beams (271) and (272), a load beam connecter (26), a loading shelf (32) with an anchor point (17), and top (29), middle (43), and bottom loading crossbeams (28), as shown in FIG. 2. Importantly, the movable loading base (31) also includes a securing system (19) at the proximal end (311). In the depicted embodiments, the securing system (19) is a retractable ratchet tie-down (11) attached to a support deck (10) and mounted to the load beam connecter (26). Such retractable ratchet tie-downs (11) are well-known in the art and would be easily understood by a person of ordinary skill in the art. Alternatively, other straps or securing means, such as though known to one skilled in the art, may be used in place of the retractable ratchet tie-down (11). Examples of such straps and securing means include, but are not limited to, bungee cords, non-retractable straps, and those that are often used to secure cargo to a car, truck, or trailer. In an embodiment, the system could use, for example, the securing means disclosed in any or all of United States Pat. No. 7,575,224, No. 6,059,499, No. 5,368,281, No. 5,282,706, and No. 4,842,458, the entire disclosures of which are incorporated herein by reference).

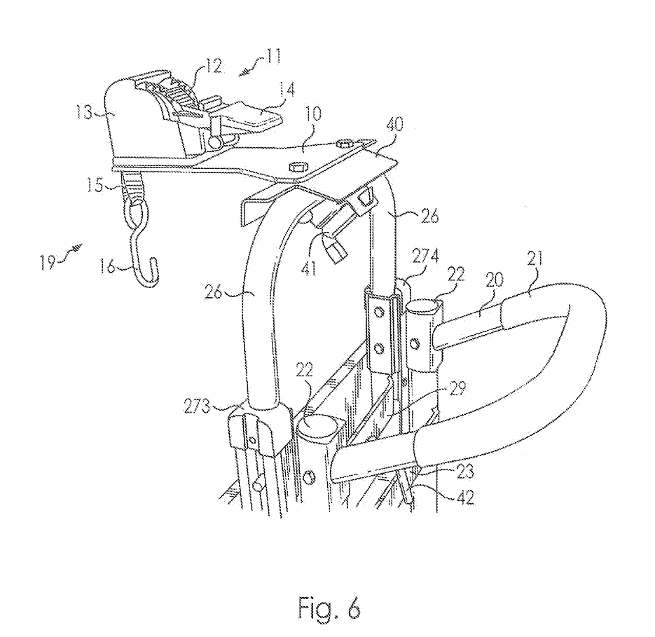

The retractable ratchet tie-down (11) in the depicted embodiments includes a retractable ratchet (12) enclosed in a housing member (13), an engaging member (14), a strap (15), and a hook (16) connected to the strap (15), as shown at least in FIG. 6. The strap (15) is pulled to a sufficient length such that the strap (15) extends over the cable boxes (71) and the hook (16) of the strap (15) connects to the anchor point (17), as shown in FIGS. 7 and 8. The engaging member (14) is then repeatedly depressed, activating the retractable ratchet (12), until the strap (15) is fully taut and the cable boxes (71) are snug in place, securing the cable boxes thereby to the movable loading base (31) of the hand delivery cart (100), as suggested by FIGS. 1 and 7. The strap (15) can then be loosened by raising the engaging member (14) which releases the retractable ratchet (12).

When engaged, this retractable ratchet tie-down (11) serves both to secure the cable wire boxes (71) while transporting to the installation site and for aiding in the cable wire dispersal and removal. With the cable wire boxes (71) firmly in place, the cable wire can be both transported and removed with greater ease than with past practices, as discussed more fully below. As a result, it is more ergonomically acceptable and economically efficient, as a single user can transport and remove the wire. Furthermore, the securing system (19) is useful with any size and type of cable wire box (71). The easy adjustability of the strap (15) allows boxes of varying sizes to all be transported and secured on a single device. For example, cable boxes (71) of varying sizes can all be transported on the hand delivery device (100) and secured with the securing system (19), as shown in FIGS. 7 and 8. Also, the securing system (19) is very useful in removal of cable wire, which can be stored in any manner, whether it be a reel inside a box or otherwise.

As shown in FIG. 10, the hand delivery device (100) may additionally include a cable guide (700). This cable guide (700) comprises an arm (701) and a wire holder (702). As shown in the embodiment in FIG. 10, the arm (701) is connected to the movable loading base (31) and extends therefrom with the wire holder (702) at the opposite end. This cable guide (700) aids in the removal of wire from the cable boxes, particularly when numerous different wires are being installed and pulled from various different boxes. In other words, the cable wire can be pulled from the boxes and through the wire holder (702). As a result, the wires can be consolidated when being removed. This cable guide (700), thus, as the name suggests, helps guides and keep together the numerous cables that are being pulled from various different boxes. This additionally aids in keeping the cable boxes in place on the hand delivery device (100).

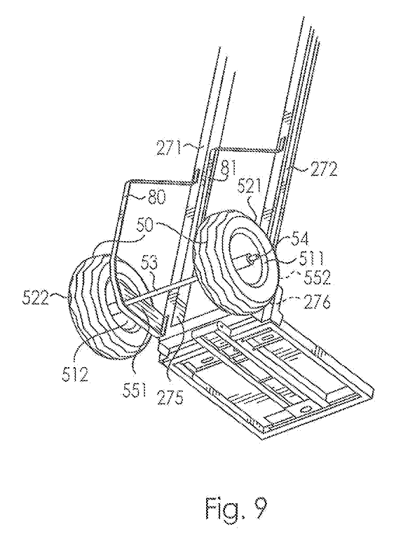

As shown in FIGS. 1-3 and 6-7, the load beam connecter (26) of the movable loading base (31) is coupled to the top ends (273) and (274) of the loading support beams (271) and (272). As shown in FIG. 6, an angled-position connecter (40) and an angled-position lock (41) are connected to the loading beam connecter (26). As shown in FIG. 2, the top (29), middle (43), and bottom loading crossbeams (28) are each generally perpendicularly connected to both loading support beams (271) and (272). A dolly position lock (42) is generally rotateably connected to the top loading crossbeam (29). As shown in FIGS. 1-4 and 7-8, the loading shelf (32) is in the shape of an “L” and is connected to both loading support beams (271) and (272) at the distal end (312) of the movable loading base (31) and extending towards the proximal end (311). The “L” shape of the loading shelf (32), however, is by no means necessary. Alternatively, the loading shelf itself may instead be flat and hingedly connected to an extension (320), as shown in FIG. 9, or a guide rail (1600) as shown in FIGS. 11-13 and described more fully below.

In any event, the loading shelf (32) provides additional support to the movable loading base (31) and helps to support the cable wire boxes (71). Axle mounts (551) and (552) are connected to the bottom ends (275) and (276) of the loading support beams (271) and (272), as shown and suggested in FIGS. 1, 2, and 9. As shown in FIG. 9, the movable loading base (31) of the hand delivery device (100) may also include stair glides (80) and (81) connected to both the loading support beams (271) and (272) and the axle mounts (551) and (552). As the terms suggests, stair glides are useful when using the hand delivery device (100) to transport cable wire boxes (71) up or down stairs.

As shown in FIG. 9, in an embodiment, the hand delivery device (100) includes two wheels (50), each of which includes a rim (511) and (512), a tire (521) and (522), and a single axle (53), and both provide support to the hand delivery device (100) and facilitates movement. In the depicted embodiments, the axle (53) is coupled to the rims (511) and (512) and rotateably connected to the axle mounts (551) and (552) such that the rims (511) and (512) provide support and rotate freely. Two tires (521) and (522), preferably 10-inch pneumatic tires, are connected to the rims (511) and (512) and directly contact the ground (70), as shown in FIGS. 1-4 and 7-8. Although the wheels of the depicted embodiments disclose a combination of rims and tires, this is by no means necessary, as one skilled in the art would recognized that solid wheels and other similar concepts would suffice. However, the tires (521) and (522) protect the rims (511) and (512) and enable better performance by providing a flexible cushion that absorbs shock while keeping the wheels (50) in close contact with the ground (70).

The loading connecter (44) is between the proximal end (311) and the distal end (312) of the movable loading base (31) and is hingedly connected to the distal end (451) of the link (45), and at the opposite, proximal end (452), the link (45) is hingedly connected to the bottom end (302) of the handle assembly (30). The link (45) serves to connect the movable loading base (31) to the handle assembly (30) and allows the hand delivery device (100) to convert between the various positions, as discussed more fully below.

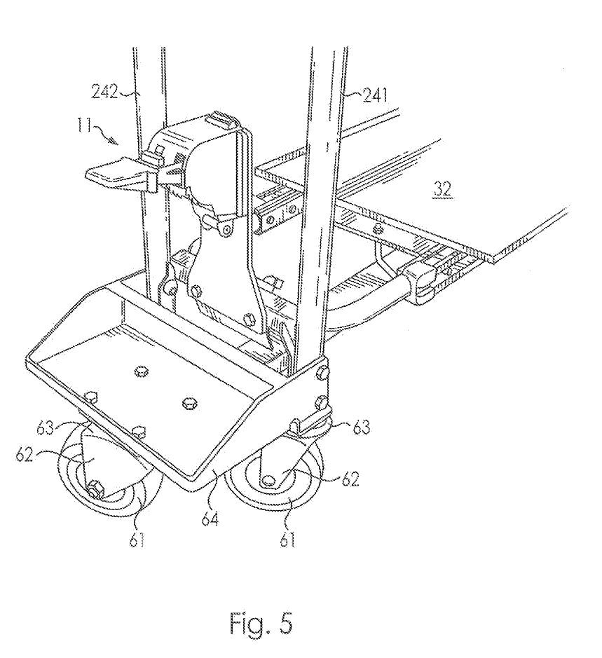

As shown in FIGS. 1-4 and 7-8, the handle assembly (30) has a top end (301) and a bottom end (302) and includes a handle (20) connected to handle support beams (241) and (242) by way of the handle connectors (22). In the depicted embodiments, a grip (21), preferably an elastomer, is wrapped around the handle (20). The handle support beams (241) and (242) remain perpendicular to the floor surface at all times when the hand delivery device (100) is being used in the angled cart position or the flat cart position. However, the handle support beams (241) and (242) may become diagonal to the floor surface when the hand delivery device (100) is used in the two-wheeled dolly position, as suggested in FIG. 3. The handle support beams (241) and (242) are perpendicularly connected together by a mid-handle crossbeam (23) and a bottom stabilizer (25). As shown in FIG. 8, there is a hole (47) in the mid-handle crossbeam (23) and a handle connector (46) in the middle of the bottom stabilizer (25), which serves to rotateably connect the handle assembly (30) to the link (45). The handle support beams (241) and (242) also connect the bottom end (302) of the handle assembly (30) to the frame (64) of the casters (60), as shown in FIG. 5.

In an embodiment, the casters (60) generally comprise at least one of what is well-known in the art as a swivel caster. The swivel caster incorporates a swivel wheel (61) mounted to a fork (62), with a swivel joint (63) above the fork (62) which allows the fork (62) to freely rotate about 360°, thus enabling the wheel (61) to roll in any direction, as shown and suggested in FIG. 5. This makes it possible to easily move the hand delivery cart (100) in any direction without changing its orientation. In one embodiment, as shown in FIGS. 1-5, the caster (60) includes three swivel casters each mounted to a frame (64), which is connected to the handle support beams (241) and (242) and bottom stabilizer (25). While the depicted embodiments include three swivel casters, this is by no means necessary, and the hand delivery cart (100) could have as many or as few swivel casters as desired. One or more of the swivel casters also preferably includes a foot-activated lever (65), which serves to anchor and lock the hand delivery cart (100) in place, for example when loading or unloading the cable boxes (71), as shown and suggested in FIGS. 1, 7 and 8 and described more fully below. In an alternative embodiment, the hand delivery device (100) may include a different means for locking the casters, such as those known to one of ordinary skill in the art. Examples include, but are not limited to, a clevis pin or a wheel lug nut lock. The swivel wheel (61) may also be coated in a protective material, such as an elastomer; however, this coating is by no means necessary.

In the angled cart position, the movable loading base (31) is connected to the handle assembly (30) near the handle connectors (22) of the handle support beams (241) and (242), resulting in the movable loading base (31) being angled to the ground (70), as suggested in FIGS. 1 and 7. In this position, the angled-position connector (40) is removably attached to the mid-handle crossbeam (23). To removably attach the angled-position connector (40) to the mid-handle crossbeam (23), the angled-position lock (41) is inserted into the hole (47) of the mid-handle crossbeam (23). The link (45) also serves to connect the movable loading base (31) to the handle assembly (30).

The hand delivery device (100) can be converted from an angled cart (FIGS. 1 and 7) to a flat cart (FIGS. 4 and 8) by removing the angled-position lock (41) from the hole (47) of the mid-handle crossbeam (23) and lowering the movable loading base (31) until it is substantially perpendicular to the handle assembly (30). In the flat cart position, the angled-position connector (40) lies on top of the bottom stabilizer (25), keeping the movable loading base (30) vertically in place relative to the ground (70). The link (45) serves to connect the movable loading base (31) to the handle assembly (30) and restricts the horizontal movement of the movable loading base (31) relative to the handle assembly (30).

The hand delivery device (100) can be converted from a flat cart (FIGS. 4 and 8) to a two-wheeled dolly (FIGS. 2 and 3) by lifting the movable loading base (31) until it is substantially parallel to the handle assembly (30). The dolly position lock (42) is turned to a downward vertical position such that dolly position lock (42) connects to the mid-handle crossbeams and secures the movable loading base (31) to the handle assembly (30), as suggested by FIG. 2.

As suggested by FIGS. 1 and 2, the hand delivery device (100) can be converted from the two-wheeled dolly position (FIGS. 2 and 3) to the angled cart position (FIGS. 1 and 7) by turning the dolly position lock (42) to an upward vertical position and moving the movable loading base (31) outwardly and downwardly until the movable loading base is angular to the handle assembly (30). The angled position connector (40) then attaches to the mid-handle crossbeam (23) and the position is further secured by engaging the angled position lock (41), as described more fully above.

Generally, in the operation of the hand delivery device (100), cable boxes (71) are unloaded from a truck and placed on the shelf (32) of the hand delivery device (100). The hand delivery device (100) may be in any of the positions described when loading the device (100). For example, a user may place the cable boxes (71) on the device (100) while in the flat cart position, and the cable boxes (71) may be facing in any direction, as shown in FIG. 8. Generally, in this position and when loading, the casters (60) will preferably be locked in place with the foot-activated lever (65). This will secure the device (100) in place and prevent it from moving when loading; however, the casters (60) will be unlocked once transportation begins. This position may be advantageous as the flatness aids in the ease of loading and allows for a large number of cable boxes (71) to be loaded at one time. On the other hand, the two-wheeled dolly position (FIG. 2) may be advantageous if the user will be transporting smaller loads and when making many turns when transporting from the site of delivery to the site of installation. Once loaded, the cable boxes (71) are secured to the device (100) with the securing system (19) or securing means.

Once loaded and secured (100), a user can then transport the cable boxes (71) on the hand delivery device (100) from the site of delivery to the site of installation. Once transported to the installation site on the hand delivery device (100), the cable wire is dispensed from the cable boxes (71). However, the device (100) can also still convert among the various positions with ease at anytime and without the need of removing the cable boxes (71). For example, the device (100) may be in the dolly position or the flat cart position when transporting, but then converted to the angled cart position when dispensing the cable wire. The angled cart position may be especially advantageous if the wire is to be installed at a greater height, such as the ceiling. Once in the angled cart position, the cable boxes (71) will be closer to the ceiling and at a preferable angle. Also, as described above and below, the cable boxes (71) may be placed on the device (100) in such a manner that the wire may be removed from the front, back, side or top of the device (100), as suggested in FIGS. 7 and 8. Additionally, as described above and shown in FIG. 10, the hand delivery device (100) may additionally include a cable guide (700) to aid in the removal of wire from the cable boxes, particularly when numerous different wires are being installed and pulled from various different boxes.

When dispensing the cable wire, the hand delivery device (100) is preferably already in, or converted to, either the angled cart position (FIGS. 1 and 7) or the flat cart position (FIGS. 4 and 8), as opposed to the two-wheeled dolly position. Furthermore, the swivel casters are generally locked in placed by the foot-activated levers (65). This serves to keep the hand delivery device (100) stationary when removing the cable wire. Alternatively, a user could keep the hand delivery device (100) stationary by placing his/her foot securely on the device. The cable boxes (71) are further secured in place with the securing system (19), as described more fully above, which allows for varying sizes and type of cable boxes (71). With the hand delivery device (100) stationary and the cable boxes (71) secured and restrained in place, the cable wire can be removed with ease and without the need of an additional user. While the cable wire is preferably removed from the sides of the cart, the securing system (19) is designed to allow for additional removal from the front, back, or top, as suggested in FIGS. 7 and 8.

Because of the design of the hand delivery device (100) and the operation of the securing system (19), as described more fully above, any size cable box (71), or various different sizes, can all be transported at one time, as shown in FIGS. 7 and 8. Also, the cable wire does not need to be on a reel inside the cable box (71) and can advantageously be simply coiled when stored in the cable boxes (71).

Turning now to FIGS. 11-13, another embodiment of the hand delivery (1000) is shown that does not convert among the various positions. Instead, the hand delivery device (1000) remains in the flat cart position. However, the hand delivery device (1000) can be converted into a folded position, as shown in FIG. 12.

In an embodiment, the hand delivery device (1000) includes a securing system (1019) and a movable loading base (1031) with wheels (1050) connected thereto and a handle assembly (1030) with casters (1060) connected thereto, as similarly described above in reference to FIGS. 1-10. The bottom end (1302) of the handle assembly (1030), however, is now hingedly connected to the proximal end (1311) of the movable loading base (1031). The distal end (1312) of the movable loading base (1031) is in turn hingedly connected to the guide rail (1600). As suggested by FIGS. 11-12, the hand delivery device (1000) can be converted from the flat cart position (FIG. 11) to the folded form (FIG. 12) by folding the handle assembly (1030) and the guide rail (1600) down to the movable loading base (1031). Alternatively, the guide rail (1600) may merely be an extension (320) to the loading shelf (32), as shown in FIG. 9.

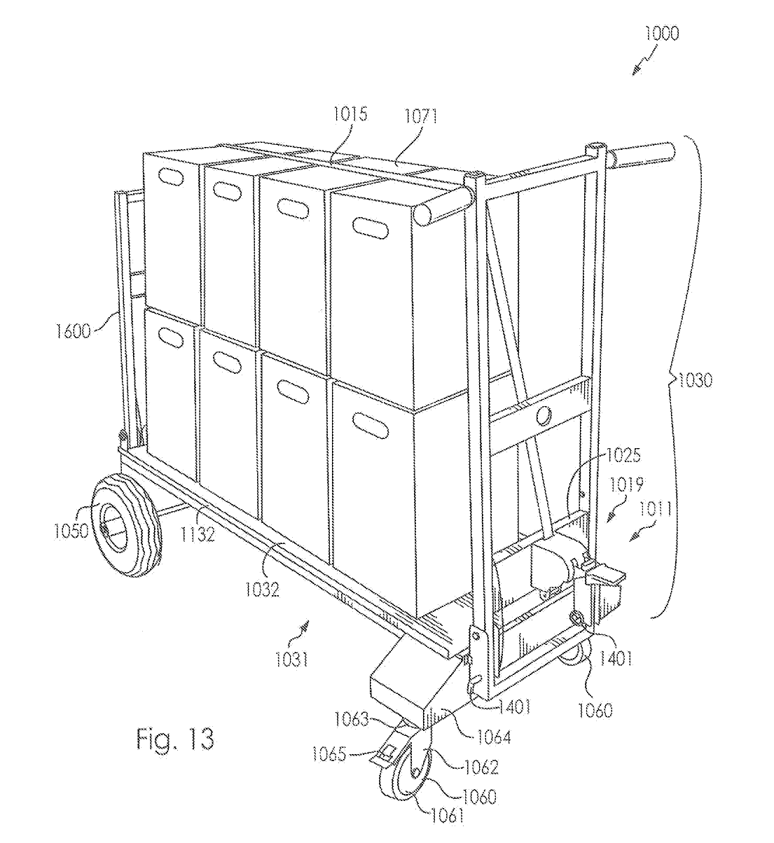

The movable loading base (1031), as defined herein, has a proximal end (1311) and a distal end (1312) with an anchor point (1017) at the distal end (1312), is load bearing, and comprises a loading shelf (1032) with raised edges ((1132) and (1232)), as shown in FIG. 11. These raised edges ((1132) and (1232)) help keep the cable boxes securing in place, as suggested in FIG. 13.

The movable loading base (1031) is hingedly connected to the bottom end (1601) of the guide rail (1600). The guide rail (1600) additionally has pull pins (1402) to lock the guide rail (1600) in position, either in flat cart or folded form. Additionally, the guide rail (1600) has a hole (1603) which is substantially parallel with the hole (1047) on the handle assembly (1030) when the device (1000) is in the flat cart position, as shown in FIG. 11.

The wheels (1050) are connected to the movable loading base (1031) in the same manner as described above, i.e., with axle mounts connected to movable loading base (1031), or alternatively, to the guide rail (1600). As suggested in FIGS. 11-13, in an embodiment, the hand delivery device (1000) includes two wheels (1050), each of which includes a rim (1511) and (1512), a tire (1521) and (1522), and an axle (not depicted in FIGS. 11-13, but described above and shown in at least FIG. 9), and both provide support to the hand delivery device (1000) and facilitate movement. The axle is coupled to the rims and the axle mounts in the same manner described above, as are the tires and wheels.

The movable loading base (1031) is also hingedly connected to the bottom end (1302) of the handle assembly (1030). Like the guide rail (1600), the handle assembly (1030) additionally has pull pins (1401) to lock the handle assembly (1030) in position, either in flat cart or folded form.

As shown in FIGS. 11 and 13, the handle assembly (1030) is similar to the embodiment described above in reference to FIGS. 1-10. In other words, the handle assembly (1030) has a top end (1301) and a bottom end (1302) and includes a handle (1020) connected to handle support beams (1241) and (1242) by way of the handle connectors (1022). In the depicted embodiments, a grip (1021), preferably an elastomer, is wrapped around the handle (1020). The handle support beams (1241) and (1242) remain perpendicular to the floor surface at all times when the hand delivery device (1000) is being used in the flat cart position. However, the handle support beams (1241) and (1242) may become parallel to the floor surface when the hand delivery device (1000) is in folded form, as suggested in FIG. 12. The handle support beams (1241) and (1242) are perpendicularly connected together by a mid-handle crossbeam (1023) and a bottom stabilizer (1025). There is also a hole (1047) in the mid-handle crossbeam (1023). The handle support beams (1241) and (1242) also connect the bottom end (1302) of the handle assembly (1030) to the frame (1064) of the casters (1060), as shown in FIG. 11.

As similarly described above, the casters (1060) also generally comprise at least one swivel caster. The swivel caster incorporates a swivel wheel (1061) mounted to a fork (1062), with a swivel joint (1063) above the fork (1062) which allows the fork (1062) to freely rotate about 360°, thus enabling the wheel (1061) to roll in any direction. This makes it possible to easily move the hand delivery cart (1000) in any direction without changing its orientation. While the depicted embodiment in FIGS. 11-13 includes two swivel casters, this is by no means necessary, and the hand delivery cart (1000) could have as many or as few swivel casters as desired. One or more of the swivel casters also preferably includes a foot-activated lever (1065), which serves to anchor and lock the hand delivery cart (1000) in place, for example when loading or unloading the cable boxes (1071), as shown and suggested in FIG. 13. Additionally, as shown in the embodiments in FIGS. 11-13, the casters (1060) may be off-set to the side of the movable loading base (1031). This advantageously provides a wider and more sturdy hand delivery device (1000), which can be useful both when transporting and unloading cable wire and boxes.

As similarly described above, the hand delivery device (1000) includes a securing system (1019). In the depicted embodiments in FIGS. 11-13, the securing system (1019) is again a retractable ratchet tie-down (1011). The retractable ratchet tie-down (1011) operates in the same manner as described above and is connected to the device at the proximal end of the movable loading base (1031). In these embodiments, however, the retractable ratchet tie-down (1011) is connected to the bottom stabilizer (1025), but still at the proximal end of the movable loading base (1031), and the strap (1015) connects to the anchor point (1017) on the distal end of the movable loading base (1031). Alternatively, the strap could attach to the hole (1603) on the guide rail (1600). What is important is that the strap (1015) is attached at the distal end of the movable loading base and opposite of the location of the retractable ratchet tie-down (1011).

In any event, and as noted above, when engaged, this retractable ratchet tie-down (1011) serves both to secure the cable wire boxes (1071) while transporting to the installation site and for aiding in the cable wire dispersal and removal, as shown in FIG. 13. With the cable wire boxes (1071) firmly in place, the cable wire can be both transported and removed with greater ease than with past practices, as discussed more fully below. As a result, it is more ergonomically acceptable and economically efficient, as a single user can transport and remove the wire. Furthermore, and again as noted above, the securing system (1019) is useful with any size and type of cable wire box (1071). The easy adjustability of the strap (1015) allows boxes of varying sizes to all be transported and secured on a single device.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A hand delivery device for transporting and dispensing cable and wire, the device comprising:
a handle assembly having a top end and a bottom end;
a caster connected to the bottom end of the handle assembly;
a movable loading base having a proximal end and a distal end, wherein the proximal end of the movable loading base is hingedly connected to the bottom end of the handle assembly;
a wheel connected to the distal end of the movable loading base;
a guide rail hingedly connected to the movable loading base; and
a retractable ratchet tie-down having a strap, wherein the retractable ratchet tie-down is connected to the device at the proximal end of the movable loading base and wherein the strap adjustably and removably attaches to the distal end of the movable loading base.

2. The device of claim 1, wherein the caster further comprises a plurality of swivel casters including at least one foot-activated locking lever.

3. The device of claim 1, wherein the wheel further comprises a plurality of tires.

4. The device of claim 3, wherein the plurality of tires are pneumatic tires.

5. The device of claim 1, further comprising a handle connected to the top end of the handle assembly.

6. The device of claim 5, wherein the handle further comprises an elastomer grip.

7. A system for transporting and dispensing cable and wire, the system comprising:
a plurality of cable wire boxes; and
a hand delivery device comprising:
a handle assembly having a top end and a bottom end;
a caster connected to the bottom end of the handle assembly;
a movable loading base having a proximal end and a distal end, wherein the proximal end of the movable loading base is hingedly connected to the bottom end of the handle assembly;
a wheel connected to the distal end of the movable loading base;
a guide rail hingedly connected to the movable loading base; and
a retractable ratchet tie-down having a strap, wherein the retractable ratchet tie-down is connected to the device at the proximal end of the movable loading base and wherein the strap adjustably and removably attaches to the distal end of the movable loading base.

8. The system of claim 7, wherein the retractable ratchet tie-down is connected to the bottom end of the handle assembly.

9. The system of claim 8, wherein the hand delivery device further comprises a plurality of swivel casters connected to the bottom end of the handle assembly and wherein the swivel casters includes at least one foot-activated locking lever.

10. The system of claim 7, wherein the wheel of the hand delivery device further comprises a plurality of tires.

11. The system of claim 10, wherein the plurality of tires are pneumatic tires.

12. The system of claim 7, wherein the hand delivery device further comprises a handle connected to the top end of the handle assembly.

13. The system of claim 12, wherein the handle further comprises an elastomer grip.

14. The system of claim 7, wherein the plurality of cable wire boxes are different sizes.

15. The system of claim 7, wherein the plurality of cable wire boxes further comprise at least one cable wire box without a reel.

16. A system for transporting and dispensing cable and wire, the system comprising:
a plurality of cable boxes;
a hand delivery device comprising:
a handle assembly having a top end and a bottom end;
a caster connected to the bottom end of the handle assembly;
a movable loading base having a proximal end and a distal end, wherein the proximal end of the movable loading base is hingedly connected to the bottom end of the handle assembly;
a wheel connected to the distal end of the movable loading base; and
a guide rail hingedly connected to the movable loading base; and
a means for securing cable boxes such that the cable boxes are secured thereby to the hand delivery device.

17. The system of claim 16, wherein the plurality of cable wire boxes are different sizes.

18. The system of claim 16, wherein the plurality of cable wire boxes further comprise at least one cable wire box without a reel.
